(19) United States
(12) Patent Application Publication
(10) Pub. No.: US 2012/0119136 A1
(43) Pub. Date: May 17, 2012

(54) LOW GWP HEAT TRANSFER COMPOSITIONS

(75) Inventors: Samuel F. Yana Motta, East Amherst, NY (US); Mark W. Spatz, East Amherst, NY (US); Ryan Hulse, Getzville, NY (US)

(73) Assignee: HONEYWELL INTERNATIONAL INC., Morristown, NJ (US)

(21) Appl. No.: 13/292,374

(22) Filed: Nov. 9, 2011

Related U.S. Application Data
(60) Provisional application No. 61/413,000, filed on Nov. 12, 2010.

(51) Int. Cl. C09K 5/04

(52) U.S. Cl. 252/67

(57) ABSTRACT

Heat transfer compositions and methods wherein the compositions have a burning velocity (BV) of less than about 10 and a global warming potential (GWP) of less than about 400 comprising: (a) from about 0 to about 50% by weight of HFC-32; (b) from about 50% to about 90% by weight of a compound selected from unsaturated —CF3 terminated propenes, unsaturated —CF3 terminated butenes, and combinations of these; and (c) from about 0 to about 25% by weight of a compound selected from HFO-1243zf, HFC-152a, and combinations of these, provided that the combination of components (a) and (c) together comprise at least about 10% by weight of the composition, and further provided that the amount of each of the components (a), (b) and (c) is selected to ensure that the BV of the composition is less than about 10 and the GWP of the composition is less than about 400.

### CROSS REFERENCES TO RELATED APPLICATIONS

This application is related to and claims the priority benefit of U.S. Provisional Application No. 61/038,327, filed on Nov. 12, 2010, the contents of which are incorporated herein by reference.

### FIELD OF THE INVENTION

This invention relates to compositions, methods and systems having utility particularly in refrigeration applications, and in particular aspects to refrigerant compositions particularly useful in systems that have heretofore typically utilized the refrigerant HFC-404A for heating and cooling applications.

### BACKGROUND

Mechanical refrigeration systems, and related heat transfer devices such as heat pumps and air conditioners, using refrigerant liquids are well known in the art for industrial, commercial and domestic uses. Fluorocarbon based fluids have found widespread use in many residential, commercial and industrial applications, including as the working fluid in systems such as air conditioning, heat pump and refrigeration systems. Because of certain suspected environmental problems, including the relatively high global warming potentials associated with the use of some of the compositions that have heretofore been used in these applications, it has become increasingly desirable to use fluids having low or even zero ozone depletion potential, such as hydrofluorocarbons (“HFCs”). Furthermore, a number of governments have signed the Kyoto Protocol to protect the global environment setting forth a reduction of CO₂ emissions (global warming). Thus, there is a need for a low- or non-flammable, non-toxic alternative to replace certain of high global warming HFCs.

One important type of refrigeration system is known as a “low temperature refrigeration system.” Such systems are particularly important to the food manufacture, distribution and retail industries in that they play a vital role in ensuring that food which reaches the consumer is both fresh and fit to eat. In such low temperature refrigeration systems a commonly used refrigerant liquid has been HFC-404A (the combination of HFC-125:HFC-143a:HFC-134a in an approximate 44:52:4 weight ratio is referred to in the art as R-404A). R-404A has an estimated Global Warming Potential (GWP) of 3922, which is considerably higher than is desired and/or required.

There has thus been an increasing need for new fluorocarbon and hydrofluorocarbon compounds and compositions that are attractive alternatives to the compositions heretofore used in these and other applications. For example, it has become desirable to retrofit chlorine-containing refrigeration systems by replacing chlorine-containing refrigerants with non-chlorine-containing refrigerant compounds that will not deplete the ozone layer, such as hydrofluorocarbons (HFC's). Industry in general and the heat transfer industry in particular are continually seeking new fluorocarbon based mixtures that offer alternatives to, and are considered environmentally safer substitutes for, CFCs and HCFCs. It is generally considered important, however, at least with respect to heat transfer fluids, that any potential substitute must also possess those properties present in many of the most widely used fluids, such as excellent heat transfer properties, chemical stability, low- or no-toxicity, low flammability and/or lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy.

Furthermore, it is generally considered desirable for CFC and/or HFC refrigerant substitutes to be effective without major engineering changes to conventional vapor compression technology currently used with CFC and/or HFC refrigerants.

Flammability is another important property for many applications. That is, it is considered either important or essential in many applications, including particularly in heat transfer applications, to use compositions which are non-flammable or have only mild flammability. Thus, it is frequently beneficial to use in such compositions compounds which are mildly flammable, or even less flammable than mildly flammable. As used herein, the term “mildly flammable” refers to compounds or compositions which are classified as being 2 L in accordance with ASHRAE standard 34 dated 2010, incorporated herein by reference. Unfortunately, many HFC's which might otherwise be desirable for used in refrigerant compositions are flammable and classified as 2 and 3 by ASHRAE. For example, the fluoroalkane difluoroethane (HFC-152a) is flammable A2 and therefore not viable for use in neat form in many applications.

Applicants have thus come to appreciate a need for compositions, and particularly heat transfer compositions that are highly advantageous in vapor compression heating and cooling systems and methods, particularly low temperature refrigerant systems, including systems designed for use with HFC-404A.

### SUMMARY OF THE INVENTION

Applicants have found that the above-noted need, and other needs, can be satisfied according to one aspect of the invention by compositions, methods, uses and systems which comprise or utilize a multi-component mixture comprising: (a) from 0% to about 50% by weight of HFC-32; (b) from about 50% to about 90% by weight of a compound selected from unsaturated, —CF3 terminated propenes, unsaturated, —CF3 terminated butenes, and combinations of these, and (c) from 0% to about 25% by weight of HFC-152a, provided that the combination of components (a) and (c) together comprise at least about 10% by weight of the composition. Unless otherwise indicated herein, the term “% by weight” refers to the weight percent based on the total of the components (a)-(c) in the composition.

Applicants have found that the above-noted need, and other needs, can be satisfied according to another aspect of the invention by compositions, methods, uses and systems which comprise or utilize a multi-component mixture comprising: (a) from about 10% to about 50% by weight of HFC-32; and (b) from about 50% to about 90% by weight of a compound selected from unsaturated, —CF3 terminated propenes, unsaturated, —CF3 terminated butenes, and combinations of these, preferably a compound selected from HFO-1234ze, HFO-1234yf and combinations of these. In certain preferred embodiments, the compositions of this embodiment further comprise: (c) from greater than 0% to about 25% by weight of HFC-152a.

The present invention provides also methods, uses and systems which utilize the compositions of the present invention, including methods, uses and systems for heat transfer and for retrofitting existing heat transfer systems. Certain preferred method aspects of the present invention relate to methods of providing relatively low temperature cooling, such as in low temperature refrigeration systems. Other method aspects of the present invention provide methods of retrofitting an existing low temperature refrigeration system designed to contain or containing R-404A refrigerant comprising withdrawing R-404A from the system and/or introducing a composition of the present invention into the system without substantial engineering modification of said existing refrigeration system.

The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

In certain preferred embodiments, component (b) of the present invention comprises trans-HFO-1234ze (also referred to as HFO-1234ze(E)), HFO-1234yf and combinations of these.

### BRIEF DESCRIPTION OF THE FIGURES

FIG. 1 illustrates the burning velocity of mixtures of HFC-152a and HFO-1234yf.

FIG. 2 illustrates the burning velocity of mixtures of HFC-152a and HFO-1234ze(E).

FIG. 3 illustrates the burning velocity of mixtures of HFC-32 and HFO-1234yf.

FIG. 4 illustrates the burning velocity of mixtures of HFC-32 and HFO-1234ze(E).

FIG. 5 illustrates the burning velocity of a mixture of 40 wt % HFC-32, 20 wt % HFO-1234yf, 30 wt % HFO-1234ze(E) and 10 wt % HFC-152a.

### DETAILED DESCRIPTION OF PREFERRED EMBODIMENTS

Low temperature refrigeration systems are important in many applications, such as to the food manufacture, distribution and retail industries. Such systems play a vital role in ensuring that food which reaches the consumer is both fresh and fit to eat. In such low temperature refrigeration systems, one of the refrigerant liquids which has been commonly used has been HFC-404A, which has an estimated Global Warming Potential (GWP) of 3922, which is much higher than is desired or required. Applicants have found that the compositions of the present invention satisfy in an exceptional and unexpected way the need for new compositions for low temperature applications having improved performance with respect to environmental impact while at the same time providing other important performance characteristics, such as capacity, efficiency, flammability and toxicity. In preferred embodiments the present compositions provide alternatives and/or replacements for refrigerants currently used in low temperature applications, particularly and preferably HFC-404A, that at once have lower GWP values and provide a refrigerant composition that has a degree of flammability that is mildly flammable or even less flammable than mildly flammable, and which have desirably low toxicity, and preferably also have a close match in cooling capacity to HFC-404A in such systems.

### Heat Transfer Compositions

The compositions of the present invention are generally adaptable for use in heat transfer applications, that is, as a heating and/or cooling medium, but are particularly well adapted for use, as mentioned above, in low temperature refrigeration systems that have heretofore used HFC-404A and/or systems that have heretofore used R-22.

Applicants have found that use of the components of the present invention within the stated ranges is important to achieve the important but difficult to achieve combinations of properties exhibited by the present compositions, particularly in the preferred systems and methods, and that use of these same components but substantially outside of the identified ranges can have a deleterious effect on one or more of the important properties of the compositions of the invention.

For the purposes of convenience, when component (a) of the present invention comprises transHFO-1234ze, HFO-1234yf or combinations of these, it may sometimes be referred to herein as the “tetrafluoropropene component” or “TFC.”

In certain preferred embodiments, the HFC-32 is present in the compositions of the invention in an amount of from about 25% to about 45% by weight of the compositions.

In certain preferred embodiments, the compound selected from unsaturated —CF3 terminated propenes, unsaturated —CF3 terminated butenes, and combinations of these comprises HFO-1234ze, HFO-1234yf, and combinations of these, preferably where such compounds are present in the compositions in amounts of from about 50% to about 80% by weight, and even more preferably from about 50% to about 80% by weight.

In certain preferred embodiments, the compositions comprise HFC-152a in an amount from about 5% to about 20% by weight.

In certain preferred embodiments, the multi-component mixture comprises: (a) from about 10% to about 50% by weight of HFC-32; and (b) from about 50% to about 90% by weight of a compound selected from 1,1,1-trifluoropropene (HFO-1243zf), HFO-1234ze, HFO-1234yf, 1,1,1,3,3,3-hexafluorobutene (HFO-1336mzz) and combinations of these, with the amount of HFO-1243zf preferably comprising not greater than 80% by weight and even more preferably less than about 20% of the composition. In certain of such preferred embodiments, HFO-1243zf preferably is present in the composition in amount of from about 5% to about 80% by weight, and more preferably from about 5% by weight to about 20% of the composition. In certain of such embodiments, the compositions further preferably comprise: (c) greater than 0% and up to about 25% by weight of HFC-152a.

In certain preferred embodiments, the multi-component mixture comprises: (a) from about 10% to about 50% by weight of HFC-32; and (b) from about 50% to about 90% by weight of a compound selected from HFO-1234ze, HFO-1234yf, HFO-1336mzz and combinations of these; and (c) up to about 25% by weight of a compound selected from HFO-1243zf, HFC-152a and combinations of these. In certain of such embodiments, component (b) is a compound selected from HFO-1234ze, HFO-1234yf and combinations of these.

As mentioned above, applicants have found that the compositions of the present invention are capable of achieving a difficult combination of properties, including particularly low GWP. By way of non-limiting example, the following Table A illustrates the substantial GWP superiority of certain compositions of the present invention, which are described in parenthesis in terms of weight fraction of each component, in comparison to the GWP of HFC-404A, which has a GWP of 3922.

TABLE A

| | | | | GWP Rel to |
|---|---|---|---|---|
| Group | # | Composition | GWP | R404A (%) |
| Binary Pairs of | A1 | R32/R1234yf(0.3/0.7) | 205 | 5% |
| R32 with HFOs | A2 | R32/1234ze(E)(0.4/0.6) | 274 | 7% |
| and R152a | A3 | R32/R152a(0.5/0.5) | 400 | 10% |
| Ternary blends of | B1 | R32/1234ze(E)/R1234yf(0.4/0.2/0.4) | 273 | 7% |
| R32 with HFOs | B2 | R32/1234ze(E)/R1234yf(0.4/0.3/0.3) | 273 | 7% |
| | B3 | R32/1234ze(E)/R1234yf(0.4/0.4/0.2) | 273 | 7% |
| Quaternary blends of | C1 | R32/1234ze(E)/R1234yf(0.4/0.3/0.3) | 273 | 7% |
| R32, HFOs and | C2 | R32/R152a/1234ze(E)/R1234yf(0.4/0.05/0.3/0.25) | 279 | 7% |
| R152a | C3 | R32/R152a/1234ze(E)/R1234yf(0.4/0.1/0.3/0.2) | 285 | 7% |
| | C4 | R32/R152a/1234ze(E)/R1234yf(0.4/0.15/0.3/0.15) | 291 | 7% |
| | C5 | R32/R152a/1234ze(E)/R1234yf(0.4/0.2/0.3/0.1) | 297 | 8% |

Applicants have surprisingly found that in preferred embodiments of the invention wherein component (a) is HFC-32, component (b) is selected from HFO-1234ze, HFO-1234yf and combinations of these, and component (c) is selected from HFO-1243zf, HFC-152a and combinations of these, then the burning velocity of the present compositions is substantially linearly related to the weight averaged burning velocity of the components (a)-(c) according to the formula:

BVcomp=Σ(wt % i·BVi)

where BVcomp is the burning velocity of the composition, and

i is summed for each of components (a) through (c) in the composition, and preferably the amounts of each of the components (a) through (c) is selected to ensure that BVcomp based on the finding of this unexpected formula is less than about 10, more preferably less than about 9 and even more preferably less than about 8, while at the same time the GWP of the composition is less than about 400, more preferably less than about 300 and even more preferably less than about 250.

In certain preferred embodiments of the invention wherein component (a) is HFC-32, (b) is selected from HFO-1234ze, HFO-1234yf and combinations of these, and component (c) is HFC-152a, then the burning velocity of the present compositions is substantially linearly related to the weight averaged burning velocity of the components (a)-(c) according to the Formula I:

BVcomp=Σ(wt % i·BVi) I

where BVcomp is the burning velocity of the compositions, and

i represents each of components (a) through (c) in the composition, and preferably the amounts of each of the components (a) through (c) is selected to ensure that BVcomp based on the finding of this unexpected formula is less than about 10, more preferably less than about 9 and even more preferably less than about 8, while at the same time the GWP of the composition is preferably less than about 400, more preferably less than about 300, and even more preferably less than about 250.

The compositions of the present invention may include other components for the purpose of enhancing or providing certain functionality to the composition, or in some cases to reduce the cost of the composition. For example, refrigerant compositions according to the present invention, especially those used in vapor compression systems, include a lubricant, generally in amounts of from about 30 to about 50 percent by weight of the composition, and in some case potentially in amount greater than about 50 percent and other cases in amounts as low as about 5 percent.

Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils have sufficient solubility with the refrigerant that is comprised of an iodocarbon, wherein the combination of the iodocarbon and the hydrocarbon oil are more stable than other types of lubricant. Such combinations are therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

### Heat Transfer Methods and Systems

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like. In certain preferred embodiments, the compositions of the present invention are used in refrigeration systems originally designed for use with an HFC refrigerant, such as, for example, R-404A. The preferred compositions of the present invention tend to exhibit many of the desirable characteristics of R-404A but have a GWP that is substantially lower than that of R-404A while at the same time having a capacity that is substantially similar to or substantially matches, and preferably is as high as or higher than R-404A. In particular, applicants have recognized that certain preferred embodiments of the present compositions tend to exhibit relatively low global warming potentials (“GWPs”), preferably less than about 500, and more preferably not greater than about 300, and even more preferably not greater than about 250.

In certain other preferred embodiments, the present compositions are used in refrigeration systems originally designed for use with R-404A. Preferred refrigeration compositions of the present invention may be used in refrigeration systems containing a lubricant used conventionally with R-404A, such as polyolester oils, and the like, or may be used with other lubricants traditionally used with HFC refrigerants. As used herein the term “refrigeration system” refers generally to any system or apparatus, or any part or portion of such a system or apparatus, which employs a refrigerant to provide cooling. Such refrigeration systems include, for example, air conditioners, electric refrigerators, chillers, and the like.

As mentioned above, the present invention achieves exceptional advantage in connection with systems known as low temperature refrigeration systems. As used herein the term “low temperature refrigeration system” refers to vapor compression refrigeration systems which utilize one or more compressors and a condenser temperature of from about 35° C. to about 45° C. In preferred embodiments of such systems, the systems have an evaporator temperature of from about −25° C. to about −35° C., with an evaporator temperature preferably of about −32° C. Moreover, in preferred embodiments of such systems, the systems have a degree of superheat at evaporator outlet of from about 0° C. to about 10° C., with a degree of superheat at evaporator outlet preferably of from about 4° C. to about 6° C. Furthermore, in preferred embodiments of such systems, the systems have a degree of superheat in the suction line of from about 5° C. to about 15° C., with a degree of superheat in the suction line preferably of from about 5° C. to about 10° C.

### EXAMPLES

The following examples are provided for the purpose of illustrating the present invention but without limiting the scope thereof.

### Example 1

### Flammability of HFC-152a Mixtures

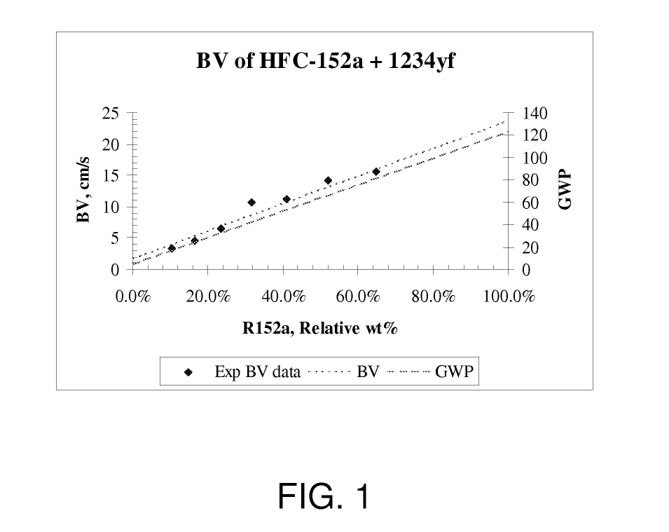

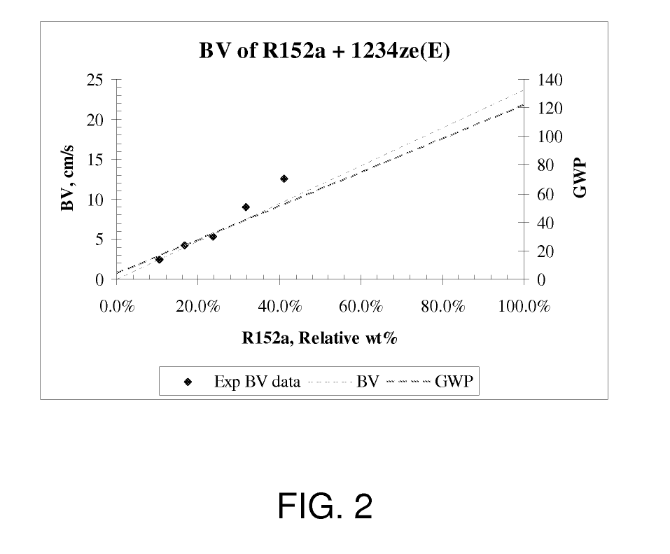

Burning velocity (BV) measurements for certain HFC-152a/HFO-1234yf and HFC-152a/HFO-1234ze(E) blends are shown in FIGS. 1-2. The burning velocity measurements were performed using the vertical tube method described in ISO standard 817 and ASHRAE standard 34. FIGS. 1-2 also show the GWP of the mixtures. The results in FIGS. 1-2 illustrate applicants' unexpected finding that the maximum burning velocity can closely be approximated by a linear relationship with wt % of the components. According to certain preferred embodiments, therefore, the amount of the components of the present invention is selected according to the Formula I provided above, that is, by approximating the burning velocity of the blends by using the wt % pure component burning velocity. In preferred embodiments, the compositions comprise up to about 30 wt % of HFC-152a, more preferably up to 20% of HFC-152a, while still exhibiting a burning velocity of the blend that is below about 10 cm/s and thus constituting a 2 L refrigerant.

### Example 2

### Flammability of HFC-32 Mixtures

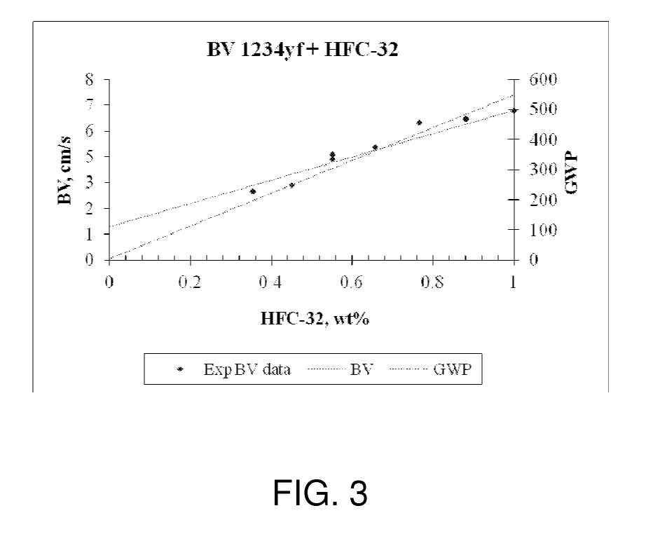

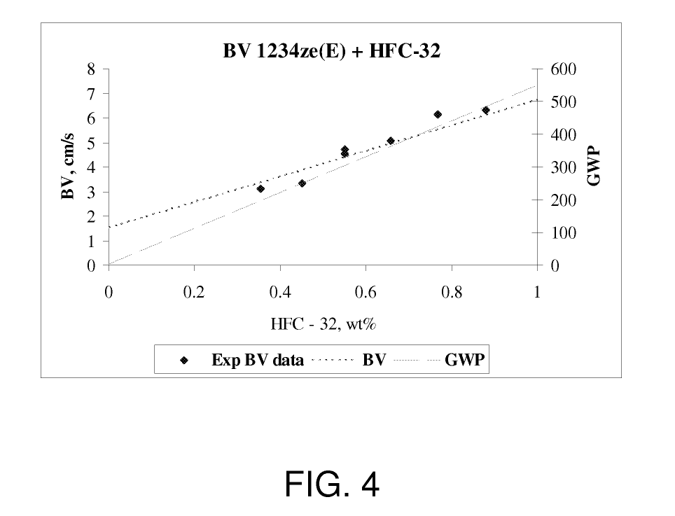

Burning velocity (BV) measurements of the HFC-32/HFO-1234yf and HFC-32/HFO-1234ze(E) blends are shown in FIGS. 3-4. The burning velocity measurements were performed using the vertical tube method described in ISO standard 817 and ASHRAE standard 34. FIGS. 3-4 also show the GWP of the mixtures. The results in FIGS. 3-4 confirm that the maximum burning velocity can closely be approximated by a linear relationship with wt % of the components.

### Example 3

### Flammability of Multi-Component Mixtures

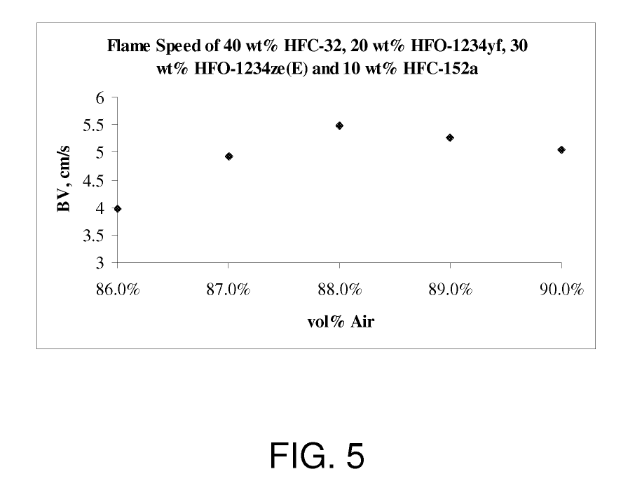

The burning velocity of a mixture of 40 wt % HFC-32, 20 wt % HFO-1234yf, 30 wt % HFO-1234ze(E), and 10 wt % HFC-152a, which is mixture #C3 in Table A was also measured and is shown in FIG. 5. In order to determine the maximum burning velocity a range of relative refrigerant composition was maintained at 40 wt % HFC-32, 20 wt % HFO-1234yf, 30 wt % HFO-1234ze(E), and 10 wt % HFC-152a, while the air composition of air was ranged from 86-90 vol %. The maximum burning velocity was 5.5 cm/s which occurred at 88 vol % air. The maximum burning velocity calculated from the wt % of the refrigerant times the pure component burning velocity was 5.3 cm/s which is in very good agreement with the experimental value.

### Example 4

### Burning Velocity of Mixtures

The burning velocities of common pure component refrigerants are given in the following Table 1. It has been discovered as described above that the burning velocity of mixtures according to the present invention can be calculated from the wt % times the pure component burning velocity as described in Formula 1 above. The burning velocities of all the mixtures in Table A were calculated and are shown below in Table 2. All of the mixtures with the exception of A3 have a burning velocity of less than 10 cm/s and therefore would be expected to be classified as A2 L refrigerants.

TABLE 1
Burning velocities of pure components

| Refrigerant | BV, cm/s |
|---|---|
| HFC-152a | 23 |
| 1243zf | 14 |
| HFC-32 | 6.7 |
| 1234yf | 1.5 |
| 1234ze(E) | 0 |
| HFC-134a | 0 |

TABLE 2
Burning velocity of mixtures

| Mixture # | BV, cm/s |
|---|---|
| A1 | 3.1 |
| A2 | 2.7 |
| A3 | 14.9 |
| B1 | 3.3 |
| B2 | 3.1 |
| B3 | 3.0 |
| C1 | 3.1 |
| C2 | 4.2 |
| C3 | 5.3 |
| C4 | 6.4 |
| C5 | 7.4 |

### Example 5

### Performance Parameters

The coefficient of performance (COP) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration to the energy applied by the compressor in compressing the vapor. The capacity of a refrigerant represents the amount of cooling or heating it provides and provides some measure of the capability of a compressor to pump quantities of heat for a given volumetric flow rate of refrigerant. In other words, given a specific compressor, a refrigerant with a higher capacity will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988).

A low temperature refrigeration system is provided. In the example of such a system illustrated in this Example, the condenser temperature is set to 40.55° C., which generally corresponds to an outdoor temperature of about 35° C. The degree of subcooling at the expansion device inlet is set to 5.55° C. The evaporating temperature is set to −31.6° C., which corresponds to a box temperature of about −26° C. The degree of superheat at evaporator outlet is set to 5.55° C. The degree of superheat in the suction line is set to 10° C., and the compressor efficiency is set to 65%. The pressure drop and heat transfer in the connecting lines (suction and liquid lines) are considered negligible, and heat leakage through the compressor shell is ignored. Several operating parameters are determined for the compositions A1-A3, B1-B3, C1, C5 identified in Table A above in accordance with the present invention, and these operating parameters are reported in Table 3 below, based upon HFC-404A having a COP value of 1.00, a capacity value of 1.00 and a discharge temperature of 87.6° C.

In certain preferred embodiments the replacement should not require substantial redesign of the system and no major item of equipment needs to be replaced in order to accommodate the refrigerant of the present invention. For that purpose the replacement preferably fulfills one or more of, and preferably all, of the following requirements:
High-Side Pressure that is within about 105%, and even more preferably within about 103% of the high side pressure of the same system using R404A. This parameter can be important in such embodiments because it can enhance the ability to use existing pressure components in such systems.
Discharge Temperature that is preferably lower than about 130° C. One advantage of such a characteristic is that it can permit the use of existing equipment without activation of the thermal protection aspects of the system, which are preferably designed to protect compressor components. This parameter is also advantageous in that it can help to avoid the use of costly controls such as liquid injection to reduce discharge temperature.
Cooling capacity that is within ±6%, and even more preferable within ±3% of the cooling capacity of the same system using R404A. This parameter is potentially important in certain embodiments because it can help to ensure adequate cooling of the product being refrigerated. It should also be noted that excess capacity can cause overload of the electric motor therefore they should be also avoided.
Efficiency (COP) that is superior to R404A without incurring ion excess capacity as noted above.
Evaporator glide preferably is below about 6.6° C. (12° F.) to avoid excessive variations of temperature along the evaporator coil and potential fractionation.
The blend is a 2 L class refrigerant.

TABLE 3

| | | | | | Ev- | Disch | |
|---|---|---|---|---|---|---|---|
| | | | Cap | Eff | Glide, | Temp. | Disch P |
| Group | # | GWP | (%) | (%) | ° C. | ° C. | (%) |
| Binary Pairs of | A1 | 205 | 101% | 108% | 4.4 | 108 | 94% |
| R32 with HFOs | A2 | 274 | 94% | 112% | 8.4 | 127 | 87% |
| and R152a | A3 | 400 | 101% | 115% | 5.7 | 156 | 87% |
| Ternary blends | B1 | 273 | 109% | 110% | 4.9 | 119 | 99% |
| of R32 with | B2 | 273 | 105% | 110% | 5.8 | 121 | 96% |
| HFOs | B3 | 273 | 101% | 111% | 6.7 | 123 | 93% |
| Quaternary | C1 | 273 | 105% | 110% | 5.8 | 121 | 96% |
| blends of R32, | C2 | 279 | 103% | 111% | 5.8 | 124 | 93% |
| HFOs and | C3 | 285 | 101% | 112% | 5.9 | 127 | 91% |
| R152a | C4 | 291 | 99% | 113% | 6.0 | 130 | 89% |
| | C5 | 297 | 97% | 114% | 6.0 | 132 | 87% |

As can be seen from the Table 3 above, applicants have found that the compositions of the present invention are capable of at once achieving many of the important refrigeration system performance parameters close to the parameters for R-404A, and in particular sufficiently close to permit such compositions to be used as replacement for R-404A in low temperature refrigeration systems and/or for use in such existing systems with only minor system modification.

For example, binary compositions A1-A3 exhibit capacities in this low temperature refrigeration system that are within about 6% of the capacity in such system of R404A.

In another embodiment, he compositions of the present invention comprise ternary blends of HFC-32, HFO-1234yf and HFO-1234ze(E). The three blends (B1, B2, B3) exhibit acceptable performance with B2 being the preferred due to the fulfillment of all requirements including the glide being lower than the maximum advisable (6.6° C.).

In another embodiment, the compositions comprise additionally HFC-152a. Such blends are preferred in many embodiments because of the superior efficiency, good capacity and low discharge temperature, while also fulfilling the requirement of BV below 10 cm/s to remain a 2 L refrigerant.

Since many existing low temperature refrigeration systems have been designed for R-404A, or for other refrigerants with properties similar to R-404A, those skilled in the art will appreciate the substantial advantage of a refrigerant with low GWP and superior efficiency which can be used as replacement for R-404A or like refrigerants with relatively minimal modifications to the system. Furthermore, those skilled in the art will appreciate that the present compositions are capable of providing substantial advantage for use in new or newly designed refrigeration systems, including preferably, low temperature refrigeration systems.

What is claimed is:

1. A heat transfer composition having a burning velocity of less than about 10 cm/s, a global warming potential of less than about 300 and capacity in low temperature refrigeration systems that is within about 10% of the cooling capacity of R-404A, said composition comprising:
(a) from about 0 to about 50% by weight of HFC-32;
(b) from about 50% to about 90% by weight of a compound selected from unsaturated —CF3 terminated propenes, unsaturated —CF3 terminated butenes, and combinations of these; and
(c) from about 0 to about 25% by weight of a compound selected from the group consisting of HFO-1243zf, HFC-152a, and combinations of these,
provided that the combination of components (a) and (c) together comprise at least about 10% by weight of the composition, and further provided that the amount of each of the components (a), (b) and (c) is selected to ensure that the burning velocity of the composition is less than about 10, the global warming potential of the composition is less than about 300, and the capacity in low temperature refrigeration systems is within about 10% of the cooling capacity of R-404A.

2. The heat transfer composition of claim 1 wherein said component (b) is a compound selected from the group consisting of HFO-1234ze, HFO-1234yf, and combinations of these.

3. The heat transfer composition of claim 1 wherein said component (a) is present in the composition in an amount of at least about 1% by weight.

4. The heat transfer composition of claim 1 wherein said component (c) is present in the composition in an amount of at least about 1% by weight.

5. The heat transfer composition of claim 4 wherein said component (c) comprises HFC-152a.

6. The heat transfer composition of claim 4 wherein said component (c) comprises HFO-1243zf.

7. A heat transfer composition comprising:
(a) from about 0% to about 50% by weight of HFC-32;
(b) from about 50% to about 90% by weight of a compound selected from unsaturated,-CF3 terminated propenes, unsaturated,-CF3 terminated butenes, and combinations of these; and
(c) from about 0 to about 25% by weight of a compound selected from the group consisting of HFO-1243zf, HFC-152a, and combinations of these,
wherein the burning velocity of the compositions is less than about 10 and is substantially linearly related to the weight averaged burning velocity of the components.

8. The heat transfer composition of claim 7 wherein said component (b) is a compound selected from the group consisting of HFO-1234ze, HFO-1234yf, and combinations of these.

9. The heat transfer composition of claim 7 wherein said component (a) is present in the composition in an amount of at least about 1% by weight.

10. The heat transfer composition of claim 7 wherein said component (c) is present in the composition in an amount of at least about 1% by weight.

11. The heat transfer composition of claim 10 wherein said component (c) comprises HFC-152a.

12. The heat transfer composition of claim 10 wherein said component (c) comprises HFO-1243zf.

13. A heat transfer composition having a burning velocity of less than about 10, a global warming potential of less than about 300 and capacity in low temperature refrigeration systems that is within about 10% of the cooling capacity of R-404A, said composition comprising:
(a) from about 10% to about 50% by weight of HFC-32;
(b) and from about 50% to about 90% by weight of a compound selected from unsaturated —CF3 terminated propenes,
provided that the amount of each of the components (a) and (b) is selected to ensure that the burning velocity of the composition is less than about 10, the global warming potential of the composition is less than about 300, and the capacity in low temperature refrigeration systems is within about 10% of the cooling capacity of R-404A.

14. The heat transfer composition of claim 13 wherein said component (b) is a compound selected from the group consisting of HFO-1234ze, HFO-1234yf, HFO-1243zf, and combinations of these.

15. The heat transfer composition of claim 13 wherein said component (a) is present in the composition in an amount of at least about 1% by weight.

16. The heat transfer composition of claim 13 further comprising from about 0% to about 25% by weight of HFC-152a.

17. A heat transfer composition having a burning velocity of less than about 10, a global warming potential of less than about 300 and capacity in low temperature refrigeration systems that is within about 10% of the cooling capacity of R-404A, said composition comprising:
(a) from about 10% to about 50% by weight of HFC-32;
(b) from about 50% to about 90% by weight of a compound selected from a compound selected from the group consisting of HFO-1234ze, HFO-1234yf and combinations of these; and
(c) from about 0 up to about 25% by weight of HFC-152a, provided that the amount of each of the components (a), (b) and (c) is selected to ensure that the burning velocity of the composition is less than about 10, the global warming potential of the composition is less than about 300, and the capacity in low temperature refrigeration systems is within about 10% of the cooling capacity of R-404A.
